(19) United States
(12) Patent Application Publication
(10) Pub. No.: US 2006/0179297 A1
(43) Pub. Date: Aug. 10, 2006

(54) Server apparatus

(76) Inventors: Hayato Ikebe, Osaka (JP); Kazuya Ogawa, Mizuho-City (JP); Yoshinori Hatayama, Komaki-City (JP); Hiroshi Takemura, Aisai-City (JP); Youko Tanaka, Mizuho-City (JP)

Correspondence Address: MCDERMOTT WILL & EMERY LLP, 600 13TH STREET, N.W., WASHINGTON, DC, 20005-3096, US

(21) Appl. No.: 11/331,364

(22) Filed: Jan. 13, 2006

(30) Foreign Application Priority Data
Jan. 13, 2005 (JP) P2005-006796

(51) Int. Cl. H04L 9/00

(52) U.S. Cl. 713/153

(57) ABSTRACT

A server apparatus is configured to connect client terminal apparatuses through a communication network. The server apparatus receives a signature-attached message having a signature of a different server apparatus connected to the communication network from the different server apparatus, and verifies whether the signature attached to the signature-attached message is valid or invalid. The server apparatus also changes a connection point for the client terminal apparatus to the different server apparatus when the signature verifier verifies that the signature is valid.

### CROSS REFERENCE TO RELATED APPLICATIONS

This application is based upon and claims the benefit of priority from the prior Japanese Patent Applications No. P2005-006796 filed on Jan. 13, 2005; the entire contents of which are incorporated herein by reference.

### BACKGROUND OF THE INVENTION

1. Field of the Invention

The present invention relates to a server apparatus configured to connect a client terminal apparatus through a communication network. More specifically, the present invention relates to a server apparatus configured to verify validity of a server apparatus newly connected to a communication network.

2. Description of the Related Art

In recent years, a home network which is a communication network configured to connect a client terminal apparatus such as a security camera or a sensor to be installed in a house has been put into practical use.

In such a home network, an information processing system (a client-server system) often includes a minimal server apparatus and a small number of client terminal apparatuses to be connected to the home network at the time of introduction of a home network.

Subsequently, a high-performance server apparatus (another server apparatus) may be further added to the information processing system in response to an increase in the number of client terminal apparatuses to be connected to the home network, and a connection point for the client terminal apparatuses may be changed to the new server apparatus.

Accordingly, to facilitate a changeover operation associated with addition of the new server apparatus, there has been disclosed a method of automatically executing operations including registration of addresses of client terminal apparatuses and server apparatuses, which become necessary upon addition of a new server apparatus. Specifically, the registration is performed by use of an apparatus (an address resolution apparatus) for managing addresses for identifying the client terminal apparatuses and the server apparatuses (see Japanese Unexamined Patent Publication No. 2000-354062, p. 8-9, FIGS. 1 and 2, for example).

### BRIEF SUMMARY OF THE INVENTION

However, the above-described conventional method has the following problem. Specifically, even when an invalid server apparatus is newly connected to the home network, an address or other information of the invalid server apparatus is registered to the respective client terminal apparatuses connected to the home network. Consequently, each client terminal apparatus executes logical connection to the invalid server apparatus.

The present invention has been made in view of the above-described circumstance. An object of the present invention is to provide a server apparatus which is capable of allowing a client terminal apparatus to change a connection point to a different server apparatus only when the different server apparatus newly connected to a home network is a valid server apparatus.

To attain the object, the present invention provides the following aspects. A first aspect of the present invention provides a server apparatus configured to connect a client terminal apparatus through a communication network, which includes a signature-attached message receiver configured to receive a signature-attached message having a signature of a different server apparatus connected to the communication network from the different server apparatus, a signature verifier configured to verify whether the signature attached to the signature-attached message is valid or invalid, and a connection point changer configured to change a connection point for the client terminal apparatus to the different server apparatus when the signature verifier verifies that the signature is valid.

According to this aspect, it is possible to change the connection point for the client terminal apparatus to the server apparatus only when the server apparatus is newly connected to a communication network and is verified to be a valid server apparatus.

A second aspect of the present invention provides the server apparatus according to the first aspect, which further includes a signature attaching unit configured to attach the signature of the server apparatus to a message to be transmitted to the network, and a signature-attached message transmitter configured to transmit the signature-attached message having the signature attached by the signature attaching unit to the network.

A third aspect of the present invention provides the server apparatus according to any one of the first and second aspects, in which the connection point changer compares a feature list indicating a feature of the different server apparatus, which is included in the signature-attached message received by the signature-attached message receiver, with a feature list of the server apparatus, and the connection point changer changes the connection point for the client terminal apparatus to the different server apparatus when the feature of the different server apparatus is higher than that of the server apparatus.

A fourth aspect of the present invention provides the server apparatus according to any one of the first to third aspects, in which the signature-attached message receiver receives the signature-attached message transmitted by the different server apparatus using the user datagram protocol (UDP).

A fifth aspect of the present invention provides the server apparatus according to any one of the second to fourth aspects, in which signature-attached message transmitter transmits the signature-attached message by use of the UDP.

According to the aspects of the present invention, it is possible to provide a server apparatus which is capable of allowing a client terminal apparatus to change a connection point to a different server apparatus only when the different server apparatus newly connected to a network is a valid server apparatus.

### BRIEF DESCRIPTION OF THE DRAWINGS

FIG. 1 is an overall schematic block diagram of an information processing system according to an embodiment of the present invention.

FIG. 2 is a view showing a logic block configuration of a server apparatus according to the embodiment of the present invention.

FIG. 3 is a view showing a logic block configuration of a client terminal apparatus according to the embodiment of the present invention.

FIG. 4 is a view showing a process flow executed by a server apparatus which is newly added to the information processing system according to the embodiment of the present invention.

FIG. 5 is a view showing a process flow executed by the existing server apparatus according to the embodiment of the present invention.

FIG. 6 is another view showing the process flow executed by the existing server apparatus according to the embodiment of the present invention.

FIG. 7 is a view showing an example of a feature list stored in the server apparatus according to the present invention.

FIGS. 8A and 8B are views showing examples of a subscribe message and a redirect message to be transmitted and received in the information processing system according to the embodiment of the present invention.

### DESCRIPTION OF THE PREFERRED EMBODIMENTS

Next, embodiments of the present invention will be described below. Note that, in the following description of the drawings, the same or similar parts will be denoted by the same or similar reference numerals. However, the drawings are schematic and actual proportions of dimensions and the like are different from reality.

It is therefore recommended to determine the concrete dimensions and other features in consideration of the following description. Moreover, it is needless to say that dimensional relations or proportion may vary between the drawings.

(Overall Schematic Configuration of Information Processing System)

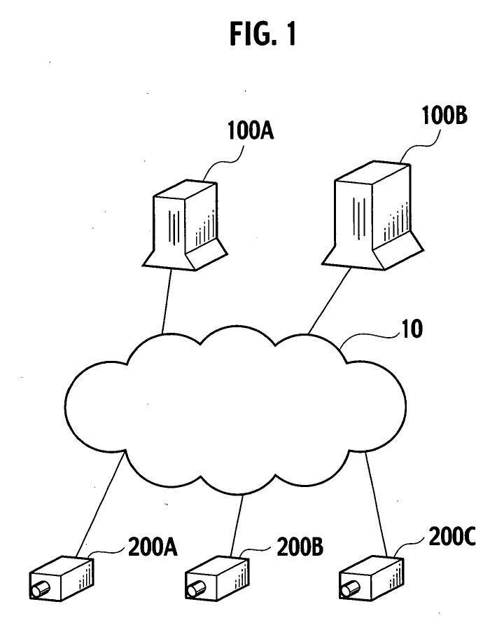

FIG. 1 shows an overall schematic configuration of an information processing system according to an embodiment of the present invention. As shown in the drawing, the information processing system of this embodiment includes servers 100A and 100B, and client terminals 200A to 200C.

The servers 100A and 100B connect the client terminals 200A to 200C through a home network 10.

The server 100A (a server apparatus) and the server 100B (a different server apparatus) offer features and processing capabilities which are different from each other. In this embodiment, the server 100B offers a higher performance than the server 100A.

The client terminals 200A to 200C are connected either to the server 100A or to the server 100B through the home network 10. In this embodiment, each of the client terminals 200A to 200C includes a security camera. Moving image data captured by the camera is transmitted to the server connected client terminals (the server 100A or the server 100B).

The home network 10 is a communication network configured to connect the servers 100A and 100B, and the client terminals 200A to 200C. The home network 10 may be formed by use of a LAN (such as 100BASE-TX) installed in a building (such as a house). Note that the home network 10 may include a wireless LAN, and the home network 10 may be connected to a wide area network (WAN) or to the Internet.

(Logic Block Configurations of Information Processing System)

Next, logic block configuration of the servers 100A and 100B, and the clients terminals 200A to 200C, which constitute the information processing system will be described.

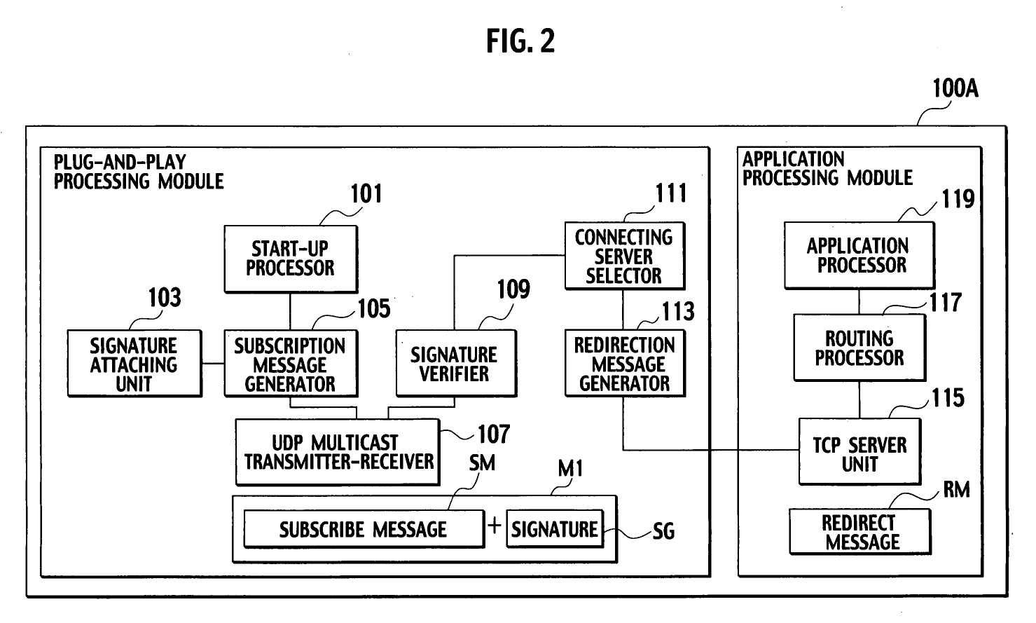

FIG. 2 shows a logic block configuration of the server 100A. The server 100B also has a similar logic block configuration to the server 100A.

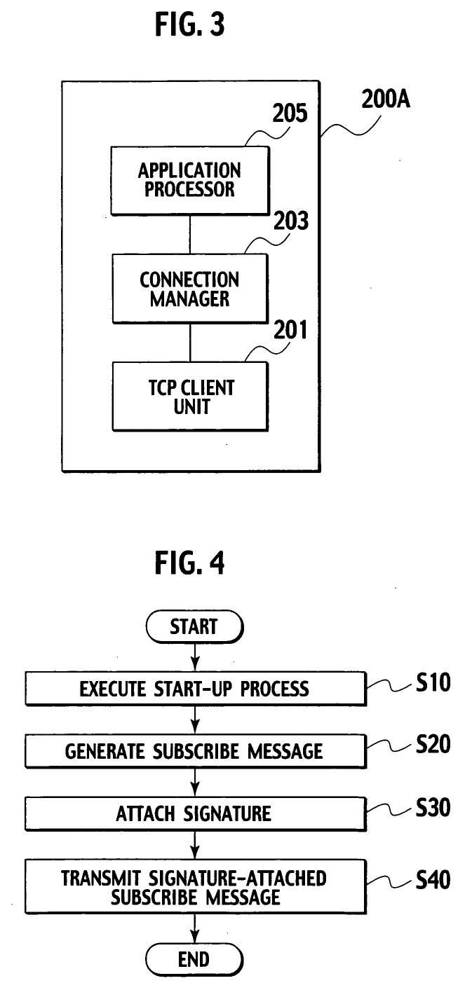

FIG. 3 shows a logic block configuration of the client terminal 200A. The client terminals 200B and 200C have a similar logic block configuration to the client terminal 200A.

Now, portions related to the present invention will be mainly explained below. Accordingly, it should be noted that the server 100A shown in FIG. 2 and the client terminal 200A shown in FIG. 3 may further include unillustrated or unexplained logic blocks (such are a power unit and the like) which are essential for realizing the features of the apparatuses.

(1) Server

As shown in FIG. 2, the server 100A includes a plug-and-play processing module and an application processing module.

The plug-and-play processing module includes a start-up processor 101, a signature attaching unit 103, a subscribe message generator 105, a UDP multicast transmitter-receiver 107, a signature verifier 109, a connecting server selector 111, and a redirect message generator 113.

The application processing module includes a TCP server unit 115, a routing processor 117, and an application processor 119.

(1.1) Plug-and-Play Processing Module

The start-up processor 101 executes a start-up process such as resetting respective logic blocks constituting the server 100A when the server 100A is turned on.

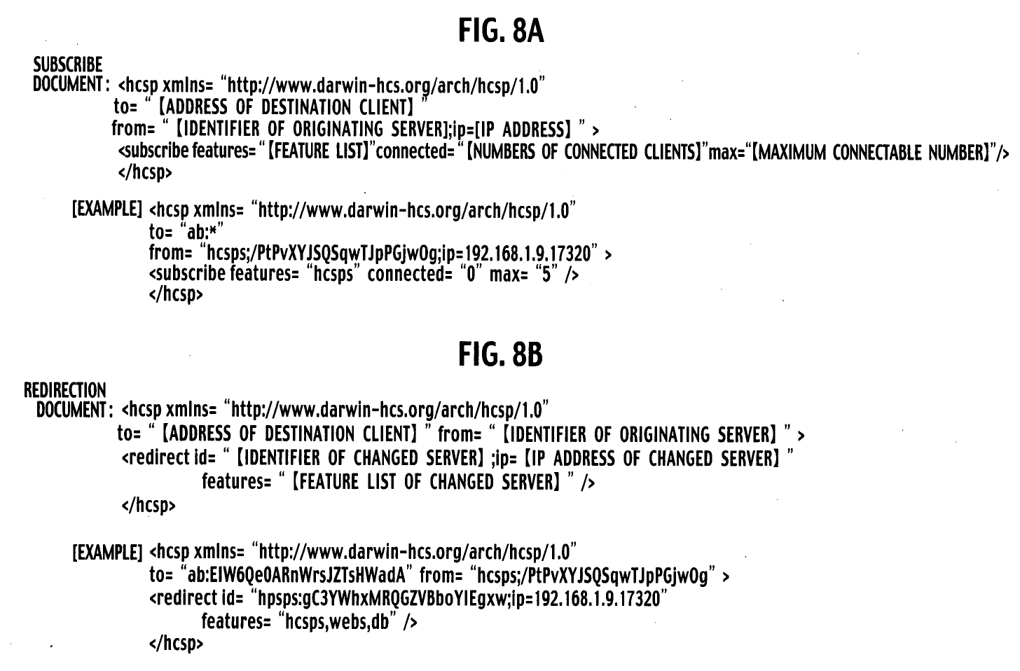

Further, the start-up processor 101 makes a request to the subscribe message generator 105 for generating a subscribe message (see FIG. 8A) to notify the start-up of the server 100A.

The signature attaching unit 103 attaches a signature SG (a digital signature) to the subscribe message SM which is transmitted to the server 100B (the different server apparatus).

Specifically, the signature attaching unit 103 attaches the signature SG to the subscribe message SM, which is generated by the subscribe message generator 105, by use of a secret key corresponding to a public key of the server 100B certified by a certificate authority (CA), and a given one-way hash function.

The subscribe message generator 105 generates the subscribe message SM to be transmitted to the server 100B.

Further, the subscribe message generator 105 makes a request to the signature attaching unit 103 for attachment of the signature to the generated subscribe message SM. The subscribe message generator 105 outputs a signature-attached subscribe message M1 (a signature-attached message), which is generated by attaching the signature SG to the subscribe message SM, to the UDP multicast transmitter-receiver 107.

The UDP multicast transmitter-receiver 107 transmits the signature-attached subscribe message M1 outputted by the subscribe message generator 105 to the server 100B.

Further, the UDP multicast transmitter-receiver 107 receives a signature signature-attached subscribe message M1 transmitted by the server 100B.

In particular, the UDP multicast transmitter-receiver 107 is configured to transmit the signature-attached subscribe message M1 (the signature-attached message) to the server 100B, and constitutes a signature-attached message transmitter in this embodiment.

Further, the UDP multicast transmitter-receiver 107 is configured to receive the signature-attached subscribe message M1 from the server 100B connected to the home network 10, and constitutes a signature-attached message receiver in this embodiment.

Note that the UDP multicast transmitter-receiver 107 transmits and receives the signature-attached subscribe message M1 using the UDP.

The signature verifier 109 verifies whether or not the signature SG attached to the signature-attached subscribe message M1 transmitted from the server 100B is valid.

Specifically, the signature verifier 109 verifies the signature SG by use of the public key of the server 100B. Moreover, when the signature verifier 109 verifies that the signature SG attached to the signature-attached subscribe message M1 is valid, the signature verifier 109 outputs the subscribe message SM included in the signature-attached subscribe message M1 to the connecting server selector 111.

The connecting server selector 111 compares a feature list indicating features of the server 100B, which is included in the signature-attached subscribe message M1 received from the server 100B, with a feature list indicating features of the server 100A.

The connecting server selector 111 compares a feature list (see FIG. 8A) indicating features of the server 100B, which is included the subscribe message SM inputted from the signature verifier 109, with a feature list (see FIG. 8B) indicating features of the server 100A. As the comparison result, when the server 100B has a higher performance than the server 110A, the connecting server selector 111 makes a request to the redirect message generator 113 for generating a redirect message RM.

The redirect message generator 113 generates the redirect message RM in response to the request from the connecting server selector 111.

The redirect message RM is for directing change of a connection point for the client terminals previously connected to the server 100A to the server 100B. In this embodiment, the connecting server selector 111 and the redirect message generator 113 constitute a connection point changer.

(1.2) Application Processing Module

The TCP server unit 115 executes processing such as establishment of logical connection to the client terminal (such as the client terminal 200A) by use of the TCP (transmission control protocol)/IP (Internet protocol).

Further, the TCP server unit 115 transmits the redirect message RM generated by the redirect message generator 113 to the client terminals 200A to 200C.

The routing processor 117 executes processing related to routing of the redirect message RM and so on which are to be transmitted to the home network 10.

Specifically, the routing processor 117 determines destination addresses of these messages and updates contents of a routing table stored therein based on received routing information.

Further, the routing processor 117 executes relaying of any messages between the TCP server unit 115 and the application processing unit 119.

The application processing unit 119 executes various applications to be offered by the server 100A (such as an application that offers a service to the client terminals 200A to 200C through the home network 10).

(2) Client Terminal

As shown in FIG. 3, the client terminal 200A includes a TCP client unit 201, a connection manager 203, and an application processor 205.

The TCP client unit 201 executes processing such as establishment of logical connection to the server (such as the server 100A) by use of the TCP (transmission control protocol)/IP (Internet protocol).

Further, the TCP client unit 201 receives the redirect message RM transmitted from the server 100A and relays the message to the connection manager 203.

The connection manager 203 manages the logical connection to the server. Specifically, the connection manager 203 makes a request to the TCP client unit 201 for release of the logical connection to the server 100A based on the redirect message RM relayed by the TCP client unit 201.

Further, the connection manager 203 executes establishment of logical connection to the server 100B after the logical connection to the server 100A is released.

The application processor 205 executes the various applications offered to the client terminal 200A. In this embodiment, the client terminal 200A includes the function of the security camera, and thereby executes processing of moving image data captured by use of a charge-coupled device (CCD; not shown) and the like.

(Operations of Information Processing System)

Next, operations of the information processing system of this embodiment will be described with reference to FIG. 4 to FIG. 8B. Specifically, operations to be executed when the server 100B (the different server apparatus) is connected to the home network as a new server apparatus will be described.

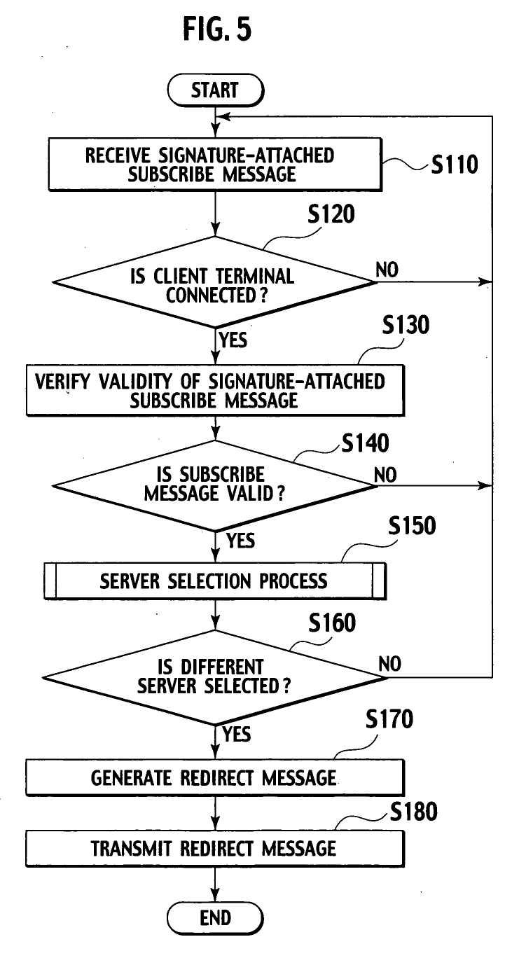

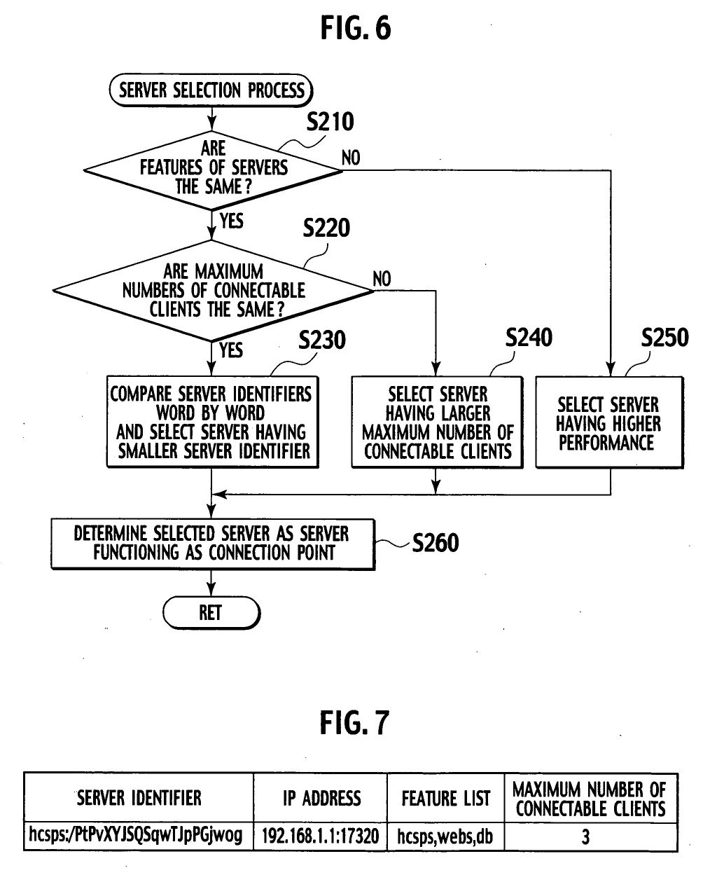

FIG. 4 shows a process flow to be executed by the server 100B. Meanwhile, FIGS. 5 and 6 show a process flow to be executed by the server 100A.

(1) Process Flow by Server 100B

First, the process flow by the server 100B will be described. As shown in FIG. 4, in Step S10, the server 100B newly connected to the home network 10 executes the start-up process. Specifically, the server 100B executes initialization of respective logic blocks that constitute the server 100B, or the like.

In Step S20, the server 100B generates the subscribe message SM upon completion of the start-up process.

In Step S30, the server 100B attaches the signature SG to the generated subscribe message SM. Specifically, the server 100B attaches the signature SG to the generated subscribe message SM by use of the secret key of the server 100B corresponding to the public key certified by the certificate authority (CA), and the given one-way hash function.

In Step S40, the server 100B transmits the signature-attached subscribe message M1 attaching the signature SG to the home network 10 by use of the UDP.

(2) Process Flow by Server 100A.

Next, the process flow by the server 100A receiving the signature-attached subscribe message M1 will be described. As shown in FIG. 5, in Step S110, the server 100A receives the signature-attached subscribe message M1 which is transmitted from the server 100B.

In Step S120, the server 100A checks whether or not there are any client terminals currently connected to the server 100A.

When there is at least one a client terminal currently connected to the server 100A (Yes in Step S120), in Step S130, the server 100A verifies validity of the received signature-attached subscribe message M1.

Specifically, the server 100A verifies the signature SG by use of the public key of the server 100B.

In Step S140, the server 100A judges whether the subscribe message SM is valid or invalid. When the signature SG is authorized, the server 100A judges that the subscribe message SM included in the signature-attached subscribe message M1 is valid.

When the subscribe message SM is judged to be invalid (No in Step S140), the server 100A repeats the processing from Step S110. In other words, the server 100A terminates the processing with the received subscribe message SM, and stands by for receiving a new signature-attached subscribe message SM.

When the subscribe message SM is judged to be valid (Yes in Step S140), in Step S150, the server 100A executes a “server selection process” as a subroutine. FIG. 6 shows the content of the server selection process.

As shown in FIG. 6, in Step S210, the server 100A compares the feature list included in the subscribe message SM transmitted from the server 100B with the feature list of the server 100A, and determines whether or not the features of those serves are at the same level.

For example, the server 100A compares the feature list (feature=“hcsps” shown in FIG. 8A), which is included in the subscribe message SM transmitted from the server 100B, with the feature list (feature=“hcsps, webs, and db” shown in FIG. 7) stored in the server 100A.

When the features are not at the same level between the servers (No in Step S210), in Step S250, the server 100A selects the server having a higher performance.

When the features are at the same level between the servers (Yes in Step S210), in Step S220, the server 100A checks whether the maximum number of connectable client terminals (max=“5” shown in FIG. 8A) are the same between the servers.

When the maximum numbers of connectable client terminals are not the same (No in Step S220), in Step S240, the server 100A selects the server having a larger value of the maximum number of connectable client terminals.

When the maximum numbers of connectable client terminals are the same (Yes in Step S220), the server compares server identifiers (see FIG. 7) word by word and selects the server having a smaller server identifier, i.e. in accordance with the alphabetical order.

In Step S260, the server 100A determines the selected server as the server functioning as the connection point for the client terminals, and terminates the server selection process.

Subsequently, as shown in FIG. 5, the server 100A checks whether or not the selected server is the server that newly connected to the home network (server 100B) in Step S160. Here, an assumption will be made that the server 100B is selected.

When the selected server is the server 100B (Yes in Step S160), in Step S170, the server 100A generates the redirect message RM (see FIG. 8B) for changing the connection point for the client terminals currently connected to the server 100A to the server 100B. Specifically, the server 100A generates the redirect message RM having an IP address of the server 100B in the IP address section (ip=192.168.1.9:17320 shown in FIG. 8B) for a destination of redirection (the server 100B).

In Step S180, the server 100A transmits the generated redirect message RM to the client terminals 200A to 200C.

Here, the client terminals 200A to 200C which receive the redirect message RM change the connection point from the server 100A to the server 100B.

(Operation and Effect)

According to the above-described information processing system of this embodiment, when the signature of the server 100B is verified as valid by the signature verifier 109 of the server 100A, the connection point for the client terminal connected to the server 100A is changed to the server 100B.

Therefore, it is possible to change the connection point for the client terminal to the server 100B only when the server 100B is newly connected to the home network 10 and is verified to be a valid server apparatus.

In other words, according to the information processing system, it is possible to prevent confusion in the information processing system due to an attempt by a client terminal to establish connection to an invalid server when the invalid server is connected to the home network 10.

Further, according to the information processing system, the connection point for the client terminals 200A to 200C is changed to the server 100B which is newly connected to the home network 10 when the feature of the server 100B is higher than that of the server 100A.

Therefore, it is possible to connect the client terminals 200A to 200C to the highest performance server connected to the home network 10.

In addition, according to the information processing system, the UDP is used for transmission and reception of the signature-attached subscribe message M1. Therefore, it is possible to suppress processing loads on the servers 100A and 100B, and the home network 10 as compared to the case of using the TCP.

### Other Embodiments

The present invention has been described above with reference to a certain embodiment. It should be noted, however, that the description and drawings constituting part of this disclosure shall not be deemed to limit the scope of the present invention. It is obvious to those skilled in the art that various substitutions and modifications are possible by the teaching of this specification.

For example, in the above-described embodiment of the present invention, the client terminals 200A to 200C have the functions of the security cameras. However, these functions are not always essential to the client terminals 200A to 200C. Meanwhile, it is also possible to apply a personal computer or the like as the client terminal.

In addition, it is also possible to combine the features of the server 100A shown in FIG. 2 and the features of the client terminal 200A shown in FIG. 3 into one apparatus.

Meanwhile, in the above-described embodiment of the present invention, the feature list of the server 100B is compared with the feature list of the server 100A, and the connection point for the client terminals 200A to 200C is changed to the server 100B when the server 100B newly connected to the home network 10 has the higher performance than the server 100A. Nevertheless, it is not always necessary that the server 100A compare the feature list of the server 100B with the feature list of the server 100A.

Moreover, in the above-described embodiment of the present invention, the UDP is used for transmission and reception of the signature-attached subscribe message M1. However, upon transmission and reception of the signature-attached subscribe message M1, it is possible to use the TCP instead of the UDP.

In this manner, it is needless to say that the present invention encompasses various other embodiments which are not expressly stated herein. In this context, the technical scope of the present invention shall be solely determined by the matter to define the present invention relevant to the appended claims that deem to be appropriate in conjunction with the above descriptions.

What is claimed is:

1. A server apparatus configured to connect a client terminal apparatus through a communication network, the server apparatus comprising:
a signature-attached message receiver configured to receive a signature-attached message having a signature of a different server apparatus connected to the communication network from the different server apparatus;
a signature verifier configured to verify whether the signature attached to the signature-attached message is valid or invalid; and
a connection point changer configured to change a connection point for the client terminal apparatus to the different server apparatus when the signature verifier verifies that the signature is valid.

2. The server apparatus of claim 1, further comprising:
a signature attaching unit configured to attach the signature of the server apparatus to a message to be transmitted to the communication network; and
a signature-attached message transmitter configured to transmit the signature-attached message having the signature attached by the signature attaching unit to the communication network.

3. The server apparatus of claim 1, wherein
the connection point changer compares a feature list indicating a feature of the different server apparatus, which is included in the signature-attached message received by the signature-attached message receiver, with a feature list of the server apparatus, and
the connection point changer changes the connection point for the client terminal apparatus to the different server apparatus when the feature of the different server apparatus is higher than the server apparatus.

4. The server apparatus of claim 1, wherein the signature-attached message receiver receives the signature-attached message transmitted by the different server apparatus using the user datagram protocol.

5. The server apparatus of claim 2, wherein the signature-attached message transmitter transmits the signature-attached message by use of the user datagram protocol.
